(19) United States
(12) Patent Application Publication
(10) Pub. No.: US 2014/0132167 A1
(43) Pub. Date: May 15, 2014

(54) FLORESCENT BALLAST TO DC POWER SYSTEM

(71) Applicant: Microtex Electronics, Richardson, TX (US)

(72) Inventors: John David Nickles, Richardson, TX (US); Mark David Siegel, Fort Worth, TX (US)

(73) Assignee: Microtex Electronics, Richardson, TX (US)

(21) Appl. No.: 14/066,691

(22) Filed: Oct. 30, 2013

Related U.S. Application Data
(60) Provisional application No. 61/796,569, filed on Nov. 15, 2012.

(51) Int. Cl. H05B 33/08

(52) U.S. Cl. CPC H05B 33/0815
USPC 315/200 R

(57) ABSTRACT

A lighting element for use in a light fixture optionally utilizing a ballast. The lighting element includes a light emitting diode having a set of input pins on opposing ends of a housing. The input pins are configured to engage the light fixture. The lighting element also includes an electronic unit in communication with the light fixture to receive an alternating current. The electronic unit has a solid state core to convert alternating current to direct current. The electronic unit is configured to regulate power to the light emitting diode. The electronic unit is coupled to the light emitting diode within the housing between the input pins, acting as a singular structure.

### BACKGROUND

1. Field of the Invention

The present application relates to conversion of high frequency florescent ballast AC voltage to DC voltage. In particular, the circuitry simulates a florescent tube in order to allow the ballast to put out stable high frequency AC for the conversion to DC.

2. Description of Related Art

The use of a florescent tube and high frequency ballast are well known in the field. The ballast takes low frequency AC, approximately 50-60 Hz, and converts it to a high frequency, 20,000 Hz for example. To ignite the gas within the tube, a transformer is typically used to produce and transmit a large voltage. If the transformer is not at its peak level when the voltage is discharged, the gas may fail to ignite. When properly discharged, rising the frequency excites the atoms within the tube to produce short-wave ultraviolet light that can then cause a phosphor in the tube to fluoresce. The ballasts typically have mechanisms that can cause the tubes to pre-heat allowing for easier ignition of the atoms. Ballasts can be magnetic or electric in nature.

Some of the difficulties with the use of florescent lights are inefficiency while running due to heat loss and the interaction with the ballast. Ballasts typically regulate the current passing through the tube and are configured to ignite the gas. If not properly functioning, ballasts “fail” and need replacing. Failed ballasts can also damage an otherwise good florescent tube. Florescent tubes themselves can lead to problems during installation. If not oriented properly, the tube may not function properly. If one wanted to switch away from florescent lights, typically the light fixture would need to be rewired increases costs and labor.

Although great strides have been made in lighting elements, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a lighting element coupled to an existing lighting fixture according to the preferred embodiment of the present application;

FIG. 2 is a diagram of an electronic unit in the lighting element of FIG. 1; and

FIG. 3 is a chart showing the operation of a processor in the electronic unit of FIG. 2.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

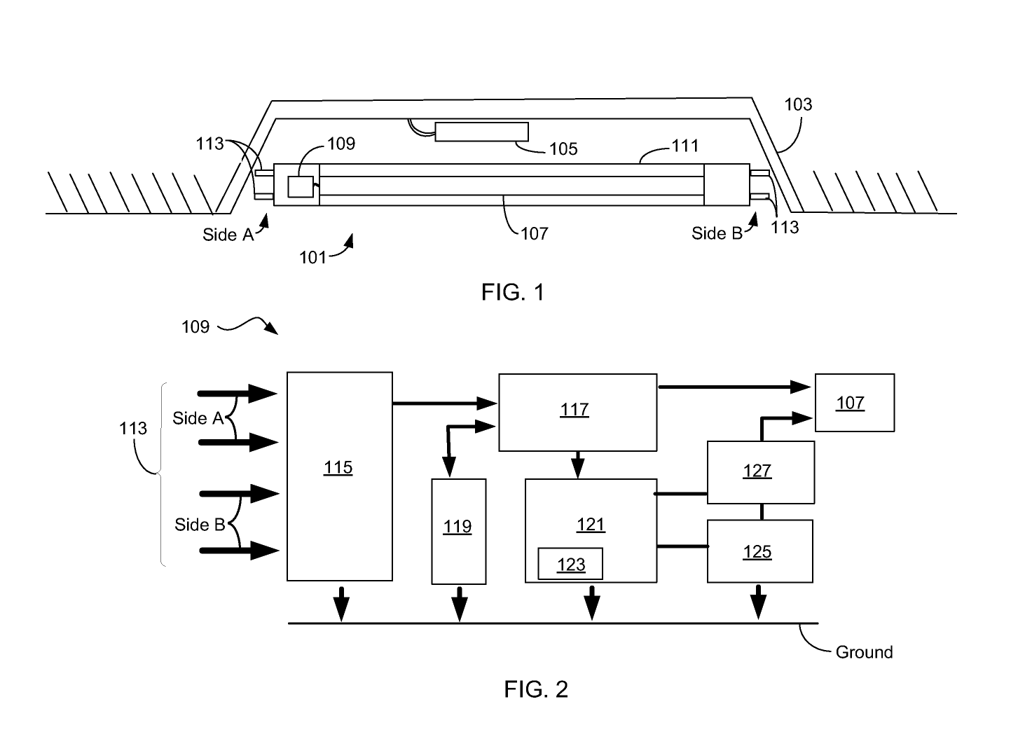

Referring now to FIG. 1 in the drawings, a lighting element 101 is illustrated. Lighting element 101 is configured to mechanically and electrically couple to a light fixture 103. Light fixture 103 is illustrated as a unit recessed into a ceiling configured to house and illuminate florescent tubes. Light fixture 103 is wired to a power source and may optionally include a ballast 105. In use, the power source is typically that of an alternating current from a residential or commercial structure. Ballast 105 is either a magnetic ballast or an electric ballast. Lighting element 101 is configured to operate with light fixtures similar to that of fixture 103.

Lighting element 101 includes a light emitting diode (LED) 107 and an electronic unit 109. LED 107 and unit 109 are mechanically and electrically coupled together within a housing 111 as a singular element. Lighting element 101 includes a set of input pins 113 positioned on opposing ends of housing 111. Unit 109 and LED 107 are located within housing 111 between input pins 113. Input pins 113 are configured engage light fixture 103 and permit the transmission of power from the power source through lighting element 101. FIG. 1 is illustrated without connectors between light fixture 103 and lighting element 101 to make input pins 113 visible. In operation, input pins are coupled to fixture 103 to allow for the transfer of energy to lighting element 101.

Unit 109 is configured to regulate power transmitted to LED 107. Unit 109 is in electrical communication with light fixture 103 to receive an alternating current from the power source. Unit 109 is configured to use a solid state core to convert the alternating current to a direct current. Unit 109 is transformer-less, meaning that unit 109 fails to require the use of a transformer to convert alternating current to direct current as seen in use by ballast 105. By not requiring the use of a transformer, typical problems associated with ballasts are avoided.

Although LED 107 has been described in a singular form, it is understood that LED 107 may include a plurality of LEDs selectively arranged in a desired pattern. For example, LED 107 may be a chain of individual light emitting diodes or may consist of one or more groups of light emitting diodes that together form LED 107.

Ballast 105 may be optionally used with light fixture 103. Where used, ballast 105 may provide a preheat function and also include a transformer used to assist in the ignition of gases within a florescent tube. The transformer generates a large startup voltage required to ignite or “kick-start” the gases in the florescent tube to produce light. Unit 109 includes one or more resistors configured to attenuate the inrush of current into lighting element 101 and to filter out the preheat phase of ballast 105. Likewise, unit 109 is configured to filter out the starting characteristics of a florescent tube so as to receive a stable alternating current frequency from ballast 105 for conversion to a stable direct current. Lighting element 101 is configured to be a singular unit that replaces a florescent tube in light fixture 103, wherein light fixture 103 is configured to run florescent lights. In so doing, lighting element 101 is a single compact replacement for florescent tubes that is configured to operate with existing florescent wiring, including ballasts 105.

The circuitry of unit 109 makes the polarity of lighting element 101 independent and the connection independent. Lighting element 101 is configured to convert the alternating current to direct current independent of voltage levels and can therefore operate with or without ballasts 105. Additionally, lighting element 101 is configured to convert the alternating current to direct current independent of input pin 113 orientation. For example, in the case of direct alternating current, one input pin 113 is power and one input pin 113 is neutral. Similarly, in the case of ballast 105 being used, one set of input pins 113 is positive and the other set of input pins 113 is set as a negative return. This allows lighting element 101 to operate within light fixture 103 independent of orientation and rotation, thereby simplifying installation. Therefore, lighting element 101 can be powered with alternating current at either side of housing 111, direct current voltage at either side of housing 111, or ballast 105 at either side of housing 111. It can be easily seen that lighting element 101 is configured to reduce costs and time associated with installation.

Referring now also to FIG. 2 in the drawings, a diagram of unit 109 is illustrated. Unit 109 may include a switching matrix 115, a power supply 117, an energy storage capacitor 119, a processor 121, an input voltage sensing unit 123, a current sensing unit 125, and a switching unit 127. It is understood that unit 109 is not hereby limited to requiring all the elements recited. It is known that other embodiments may include more or less than these, especially where systems are shared or the configuration is changed. Other configurations are contemplated and considered within the scope of the present application.

Switching matrix 115 creates a bridge circuit and steering circuitry to steer positive voltage to power supply 117 and negative voltage to ground. Power supply 117 converts the alternating current voltage to direct current voltage without respect to the voltage level and without respect to which input pins 113 are active, as stated previously. Power supply 117 routes power to energy storage capacitor 119, LED 107, and processor 121. Processor 121 monitors the voltage from power supply 117. The amount of voltage stored along with the level of current in unit 109 can change in real time. Such changes can affect the power output to LED 107. By measuring both the current and voltage, maximum wattage (power) into the system can be determined and controlled.

Processor 121 includes input voltage sensing unit 123 configured to monitor voltage levels. Processor 121 receives input data from sensing unit 123. Likewise, current sensing unit 125 is configured to monitor current levels within unit 109 and to transmit input data to processor 121. With the reception of input data from the various sources, processor 121 selectively regulates the flow of power to LED 107. Switching unit 127 is operated by processor 121, thereby allowing processor 121 to turn on and off power to LED 107.

Processor 121 is configured to selectively increase the power to LED 107 above a voltage threshold to induce LED persistence. In order to produce the highest photon emission from LED 107, the power to LED 107 is set above the threshold limit. For example, the power may be set above 50% higher than the threshold limit of LED 107. Without any control to limit exposure to the increased power, LED 107 would burn out or fail. Current sensing unit 125 monitors the rise to peak current levels to ensure no damage occurs to LED 107. When the current level is at the maximum allowable based on the desired power setting, LED 107 is switched off to permit cooling and to avoid over exposure to heat. After LED 107 has cooled sufficiently, LED 107 is switched on again through unit 127. This effect is referred to as a dynamic pulse width modulation.

In dynamic pulse width modulation, photons are emitted once the threshold limit of LED 107 is met. Those photons are accelerated to near a maximum saturation point. By pushing LED 107 to near maximum temperatures, LED 107 releases the maximum amount of photons. By immediately allowing LED 107 to cool, LED 107 does not produce extra heat while maintaining low levels of output wattage. During cooling, LED 107 continues to produce photons due to LED persistence and residual energy stored in the power supply. By selectively powering LED 107 a larger portion of power is conserved while maintaining an output of light from LED 107. Brightness levels are maintained relatively constant to the naked eye but are done at lower wattage due to overriding the threshold limit for short durations.

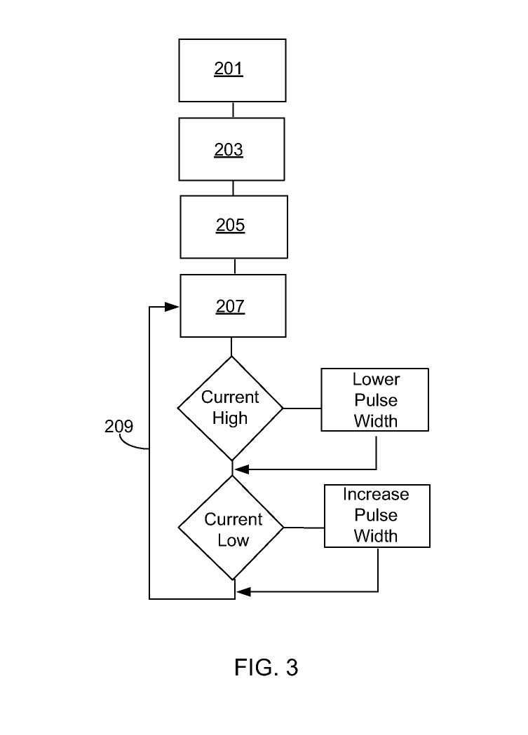

Referring now also to FIG. 3 in the drawings, a flow chart showing operation of the processor in unit 109 is illustrated. During operation, the processor is initialized 201 and reads the input data 203. A base pulse width is set 205 based partly upon the input data received and the light emitting diodes used. The processor reads the power from the input data 207. If the current is too high, the pulse width is lowered. However, if the current is too low, the pulse width is increased. The processor continually reads the power from the input data 209 to effectively monitor and regulate the power to the light emitting diodes.

The current application has many advantages over the prior art including the following: (1) increased efficiency through LED persistence and high frequency switching to conserve power; (2) solid state core; (3) single unit replacement for florescent tube lights that require no re-wiring; and (4) a lighting element independent of orientation during installation.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A lighting element for use in a light fixture, comprising:
a light emitting diode having a set of input pins on opposing ends of a housing, the input pins being configured to engage the light fixture; and
an electronic unit in communication with the light fixture to receive an alternating current, the electronic unit having a solid state core to convert alternating current to direct current, the electronic unit being configured to regulate power to the light emitting diode to produce light;
wherein the electronic unit is coupled to the light emitting diode within the housing between the input pins.

2. The lighting element of claim 1, wherein the electronic unit includes a switching matrix configured to create a bridge circuit and steering circuit to direct positive voltage to a power supply and negative voltage to a ground.

3. The lighting element of claim 1, wherein the electronic unit includes a power supply configured to convert the alternating current to direct current independent of voltage levels, the power supply receiving power through a switching unit.

4. The lighting element of claim 1, wherein the electronic unit includes a power supply configured to convert the alternating current to direct current independent of input pin orientation.

5. The lighting element of claim 1, wherein the electronic unit includes a processor configured to monitor the voltage and current passing through the light emitting diode.

6. The lighting element of claim 5, wherein the processor receives input data and is configured to selectively regulate the flow of power to the light emitting diode.

7. The lighting element of claim 1, wherein the processor includes an input voltage sensing unit configured to monitor voltage levels, the input voltage sensing unit being configured to transmit input data to the processor to regulate power levels.

8. The lighting element of claim 1, wherein the electronic unit includes a current sensing unit configured to monitor current levels, the current sensing unit being configured to transmit input data to the processor to regulate power levels.

9. The lighting element of claim 1, wherein the processor is in communication with a switching unit to selectively turn on and off the light emitting diode.

10. The lighting element of claim 1, wherein the processor is configured to selectively increase the power to the light emitting diode above a voltage threshold to induce light emitting diode persistence.

11. The lighting element of claim 1, wherein the light emitting diode is a chain composed of a group of light emitting diodes.

12. The lighting element of claim 1, wherein the electronic unit is configured to filter out a preheat phase of a ballast.

13. The lighting element of claim 1, wherein the electronic unit is configured to operate with magnetic ballasts in communication with the light fixture.

14. The lighting element of claim 1, wherein the electronic unit is configured to operate with electric ballasts in communication with the light fixture.

15. The lighting element of claim 1, wherein the electronic unit is configured to attenuate the inrush of current and to filter out the preheat phase of ballast.

16. The lighting element of claim 1, wherein the electronic unit is configured filter out an initial startup voltage used in a ballast.

17. The lighting element of claim 1, wherein the electronic unit is configured to filter out the starting characteristics of a florescent tube to receive an alternating current for conversion to a direct current.

18. A method of operating a lighting element for use in a light fixture, comprising:
initializing an electronic unit having a processor and a solid state core, the processor configured to receive input data and selectively regulate the flow of power to a light emitting diode;
setting a base pulse width;
reading input data related to current power levels; and
adjusting the pulse width in accordance with current levels.

19. The method of claim 18, further comprising:
repeatedly monitoring the input data to readjust the pulse width.
